(19) United States
(12) Patent Application Publication
(10) Pub. No.: US 2004/0096214 A1
(43) Pub. Date: May 20, 2004

(54) Method and apparatus for using optical idler tones for performance monitoring in a WDM optical transmission system

(75) Inventors: Jay P. Morreale, Summit, NJ (US); Stuart H. Mayer, Montclair, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Red Sky Systems, Inc.

(21) Appl. No.: 10/613,521

(22) Filed: Jul. 3, 2003

Related U.S. Application Data
(60) Provisional application No. 60/404,608, filed on Aug. 20, 2002.

(51) Int. Cl. H04B 10/08

(52) U.S. Cl. 398/33

(57) ABSTRACT

A test system is provided for monitoring a WDM transmission system that employs at least one optical amplifier. The test system includes a test signal generator generating an optical test signal and an optical coupler combining the test signal with at least one data signal located at a given channel wavelength. The optical test signal is located at one or more channel wavelengths distinct from the given channel wavelength and which corresponds to an idler channel wavelength that is employed to maintain a prescribed operational state of the optical amplifier. The test system also includes an optical performance monitor receiving at least a portion of the optical test signal.

### STATEMENT OF RELATED APPLICATIONS

This application claims the benefit of priority to U.S. Provisional Patent Application No. 60/404,608, filed Aug. 20, 2002, and entitled “Idler Channel Generator.”

### FIELD OF THE INVENTION

The present invention relates generally to WDM optical transmission systems, and more particularly to line monitoring equipment for assessing the status of a WDM optical transmission system in and out of service.

### BACKGROUND OF THE INVENTION

Optical wavelength division multiplexing (WDM) and dense wavelength division multiplexing (DWDM) have gradually become the standard backbone networks for fiber optic communication systems. WDM and DWDM systems employ signals consisting of a number of different wavelength optical signals, known as carrier signals or channels, to transmit information on optical fibers. Each carrier signal is modulated by one or more information signals. As a result, a significant number of information signals may be transmitted over a single optical fiber using WDM and DWDM technology. In a WDM system, when the optical signals are transmitted over long distances, periodic amplification of the optical signals is necessary. Currently, amplification is accomplished by using optical amplifiers, e.g. Erbium Doped Fiber Amplifiers (EDFAs) or Raman amplifiers. Optical amplifiers have the advantage of being relatively low in cost while being able to amplify all wavelengths without the need for demultiplexing and optoelectronic regeneration.

WDM systems currently under development are anticipated to have thirty or more channels, i.e., modulated optical signals with different wavelengths. These WDM systems place stringent demands on the optical amplifiers that are employed, especially when two or much such amplifiers are distributed along the transmission path of the WDM system, resulting in only very limited tolerances in certain parameters. Among these parameters gain flatness and gain tilt are of special importance. Gain tilt arises when there are dynamic changes in operating conditions such as the input power and wavelengths of the transmitted channels. For example, when a channel is added or subtracted, thus changing the input power and spectrum of the optical signal, a gain fluctuation occurs that depends on the channel's wavelength, effectively “tilting” the gain of the amplifier.

WDM systems are often initially deployed at less than their maximum capacity. That is, a system designed to transmit 30 channels or more, for instance, initially may be more lightly loaded with only 2, 4, or 8 channels. Since the power and wavelength distribution of the optical signal will vary as the system is upgraded to increase its channel capacity, a problem arises when a system designed for a given capacity is operated at less than that capacity. This problem occurs because, as mentioned, the changes in power and wavelength distribution of the optical signal give rise to variations in gain flatness and gain tilt, which are undesirable because the system is generally designed to operate with a specific degree of gain flatness and a particular gain tilt. In order to maintain the same gain flatness and gain tilt of the amplifiers even when the system is operating at less than full capacity, unused or idler channels are sometimes inserted along with the data-carrying channels. The idler channels are often provided as unmodulated or cw tones. As the WDM system is upgraded, idler channels can be removed and replaced with data-carrying channels.

Given that idler tones are often present before a WDM system is operating at its full capacity with a complete complement of channels, it would be advantageous if the idler tones also could be used to convey information.

### SUMMARY OF THE INVENTION

In accordance with the present invention, a test system is provided for monitoring a WDM transmission system that employs at least one optical amplifier. The test system includes a test signal generator generating an optical test signal and an optical coupler combining the test signal with at least one data signal located at a given channel wavelength. The optical test signal is located at one or more channel wavelengths distinct from the given channel wavelength and which corresponds to an idler channel wavelength that is employed to maintain a prescribed operational state of the optical amplifier. The test system also includes an optical performance monitor receiving at least a portion of the optical test signal.

In accordance with one aspect of the invention, at least one optical loopback path is associated with the optical amplifier. The optical loopback path optically couples a first unidirectional optical transmission path to a second unidirectional optical transmission path. The optical performance monitor receives a portion of the optical test signal conveyed over the optical loopback path.

In accordance with another aspect of the invention, the test signal generator includes a tone generator generating a tone having a pseudo-random sequence and an optical transmitter coupled to the tone generator for generating an optical test signal based on the pseudo-random tone.

In accordance with another aspect of the invention, the optical performance monitor includes a delay system coupled to the tone generator and for delaying the optical test signal based on a location of the optical amplifier. The optical performance monitor also includes a comparator coupled to the delay system for correlating the output of the delay system with the pseudo-random tone generated by the tone generator.

In accordance with another aspect of the invention, the optical performance monitor includes a signal performance monitor for selectively monitoring the channel wavelengths of the test signal and the data signal.

In accordance with another aspect of the invention, the signal performance monitor is a Q-monitor.

In accordance with another aspect of the invention, a method is provided for monitoring a WDM transmission system that employs at least one optical amplifier. The method begins by generating an optical test signal and at least one optical data signal located at a given channel wavelength. The optical test signal is located at one or more channel wavelengths distinct from the given channel wavelength and corresponds to an idler channel wavelength employed to maintain a prescribed operational state of the optical amplifier.

The method continues by directing the optical test signal and the optical data signal onto an optical transmission path of the WDM transmission system and monitoring a performance characteristic of the optical test signal.

In accordance with another aspect of the invention, a WDM optical transmission system is provided. The transmission system includes first and second transmitter/receiver terminals and an optical transmission path optically coupling the first transmitter/receiver terminal to the second transmitter/receiver terminal. The optical transmission path includes at least one optical amplifier. A test system is associated with the first transmitter/receiver terminal. The test system includes a test signal generator generating an optical test signal and an optical coupler combining the test signal with at least one data signal located at a given channel wavelength. The optical test signal, which is located at one or more channel wavelengths distinct from the given channel wavelength, corresponds to an idler channel wavelength employed to maintain a prescribed operational state of the optical amplifier. An optical performance monitor is provided to receive at least a portion of the optical test signal.

### BRIEF DESCRIPTION OF THE DRAWING

FIG. 1 shows a WDM transmission system that employs a monitoring system in accordance with the present invention.

FIG. 2 shows a WDM transmission system terminal that employs an alternative embodiment of the monitoring system in accordance with the present invention.

### DETAILED DESCRIPTION

The present inventors have recognized that one or more of the channels reserved as idler channels may be employed to perform line monitoring, which is generally required so that faults in the operation of the transmission system can be isolated to faulty optical amplifiers or terminals, and maintenance personnel can be dispatched to appropriate locations with appropriate information and equipment to correct the faults. Because optical amplifiers are employed, regenerated electrical signals are not available for monitoring using conventional optoelectronic repeater performance monitoring techniques. Instead, a dedicated optical channel is often reserved for performance monitoring. An optical signal transmitted over the dedicated channel is modulated by a pseudorandom sequence. At each repeater, a small portion of the optical signal is tapped by an optical coupler and coupled via a high loss optical loopback path to an optical transmission path carrying optical signals back to the terminal from which the optical signal originated. The optical signal received at the originating terminal can be digitally correlated with appropriately delayed versions of the transmitted pseudorandom sequence to separate portions of the received signal that result from each optical loopback connection. The separated portions of the received signal are averaged over time to estimate the net gain or loss of the transmission paths to each of the EDFAs and back. In addition to simply monitoring the net gain or loss along the transmission path, system performance can be evaluated in terms of the Q factor, which is a measure of performance that can be related to both the bit error rate (BER) and the optical-signal-to-noise ratio (OSNR).

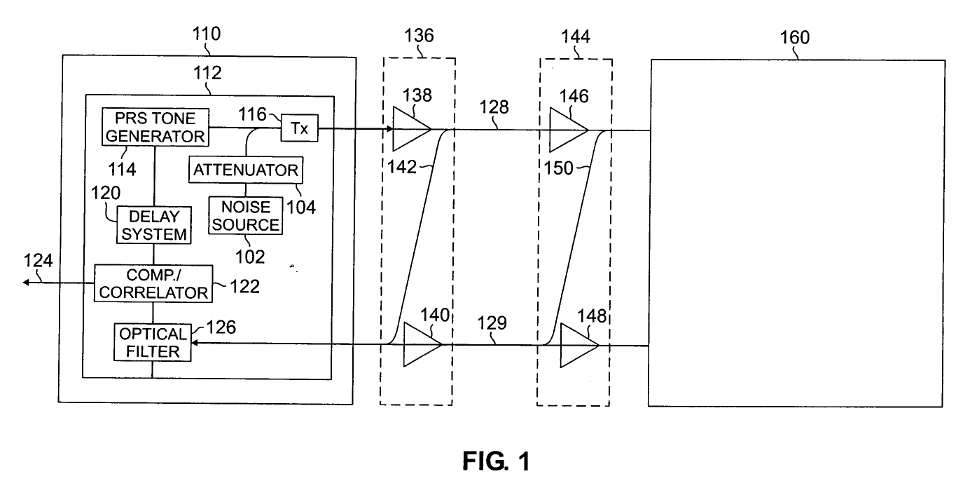

In the present invention, one or more of the idler channels serves as the dedicated monitoring channel or channels. In this way equipment that is already deployed to maintain the correct operational state of the optical amplifiers also can be used to convey information about the status of the transmission system. While the present invention encompasses any performance monitoring technique that employs a dedicated channel, for purposes of illustration only one such technique will be presented below in connection with FIG. 1. Other techniques may involve measures of system performance, including but not limited to, the Q-factor, BER and OSNR.

FIG. 1 illustrates a WDM transmission system that employs a monitoring system in accordance with the present invention. As shown, terminals 110 and 160 are in communication with one another over an optical transmission path that comprises optical fibers 128 and 129, which are unidirectional fibers that carry signals in opposite directions. Fibers 128 and 129 together provide a bidirectional path for transmitting signals. The transmission path also includes one or more repeaters, two of which are depicted in FIG. 1. Repeater 136 includes amplifiers 138 and 140 for amplifying optical signals transmitted over fibers 128 and 129, respectively. Repeater 136 also includes a loop-back path 142, which returns a portion of the signal being transmitted on fiber 129 to fiber 128 for transmission to the monitoring system (i.e., LME 112). Similarly, a second optical repeater 144 includes amplifiers 146 and 148 and loop-back path 150. Additional optical repeaters, including their associated loop-back paths, may be connected to fibers 128 and 129 for periodically amplifying and returning signals thereon. The monitoring system of the present invention includes line monitoring equipment (LME) 112 located in terminal 110. A similar LME (not shown) is located in terminal 160. LME 112 includes pseudo-random sequence (PRS) tone generator 114 connected to laser transmitter 116 for generating and outputting a pseudo-random sequence of tones. In some embodiments of the invention laser transmitter 116 generates a pseudo-random optical tone that has an OSNR that can be pre-established. For example, the OSNR can be established by adding selected amounts of optical noise to the optical tone by optical noise source 102 and optical attenuator 104. As described in greater detail below, the pseudo-random optical tone is used as a test tone by LME 112 to monitor the health of the WDM transmission system.

LME 112 also includes a delay system 110 connected to PRS tone generator 114 for delaying the tones received from PRS tone generator 114. LME 112 further includes an optical filter 126 for selectively transmitting one or more wavelengths or channels, while blocking the transmission of other wavelengths. Comparator/correlator 122 is connected to delay system 120 and optical filter 126. Comparator/correlator 122 correlates the outputs of optical filter 126 and delay system 120 using well known digital signal processing techniques. Comparator/correlator 122 outputs a result 124 of the correlation operation, which is used by a computer or other systems (not shown) to diagnose faults or problems in the optical transmission system.

While not shown in FIG. 1, terminals 110 and 160 also include transmitting and receiving units. The transmitting unit generally includes a series of encoders and digital transmitters connected to a wavelength division multiplexer. For each WDM channel, an encoder is connected to an optical source, which, in turn, is connected to the wavelength division multiplexer. Likewise, the receiving unit includes a series of decoders, digital receivers and a wavelength division demultiplexer. The transmitting unit in terminal 110 transmits optical data on a plurality of channels (or wavelengths) over fiber 128 so that a plurality of data signals, each at a different wavelength, are sent over fiber 128 using wavelength-division multiplexing (WDM). Similarly, WDM data signals transmitted from terminal 160 maybe carried over fiber 129, but traveling in a direction opposite of those signals on fiber 128.

In operation, LME 112 generates a pseudo-random optical test signal at one or more of the idler channel wavelengths for use in monitoring the fiber optic transmission system. A coupler (not shown) combines the pseudo-random optical tone with the data channels transmitted by the transmitting unit for transmission over fiber 128. The WDM signal, including the data channels and the channel or channels on which the pseudo-random optical tone is provided, is amplified by optical amplifier 138 in the first repeater 136. Loop-back path 142 within repeater 136 returns a portion of the WDM signal to LME 112 over fiber 129. The second repeater 144 similarly amplifies and returns a portion of the WDM signal to LME 112 over fiber 129 via loopback path 150. Therefore, after transmitting a pseudo-random optical tone, LME 112 receives a delayed tone from each respective repeater. Optical filter 126, which receives the signals from loop-back paths 142 and 150, is wavelength selective and passes only the channel or wavelength of the pseudo-random optical tone and rejects the wavelengths of the WDM data.

Comparator/correlator 122 correlates the pseudo-random optical tones output by PRS tone generator 114 with each of the returned tones. To perform this correlation operation, delay system 120 receives the pseudo-random optical tones from PRS tone generator 114 and outputs a plurality of delayed pseudo-random optical tones to comparator/correlator 122. Delay system 120 outputs each pseudo-random optical tone after the time delays corresponding to each repeater. In other words, delay system 120 delays the pseudo-random optical tones based on the location of each repeater. This process is repeated for each pseudo-random optical tone received by the delay system 120.

Comparator/correlator 122 compares or correlates the delayed pseudo-random optical tone returned from each repeater with correspondingly delayed pseudo-random optical tones generated by PRS tone generator 114. Comparator/correlator 122 outputs a result 124 of the correlation operation that may be used by a computer or other system (not shown) for monitoring the fiber optic transmission system, including detecting and diagnosing the location of faults or other problems.

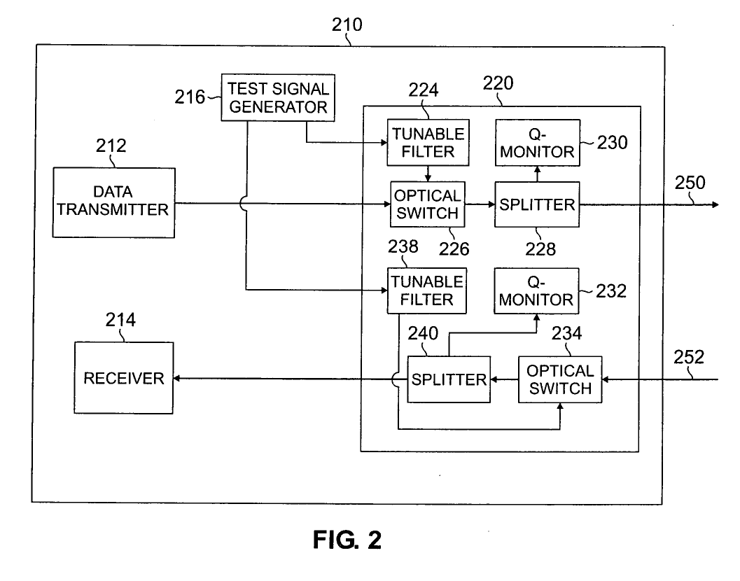

FIG. 2 shows an alternative embodiment of the invention that avoids the need for loop-back paths. FIG. 2 shows a terminal 210 that may serve as terminals 110 and 160 in the transmission system of FIG. 1. Terminal 210 includes a transmitting unit 212 for generating data-carrying channels that are to be transmitted over optical fiber 250 and a receiving unit 214 for receiving data-carrying channels that are received over optical fiber 252. A performance monitor 220 is used to monitor the performance of both the outgoing and incoming data-carrying signals. A test signal generator 216 generates the pseudo-random optical test signal at one or more of the idler channel wavelengths. The test signal generator 216 may encompass components similar to the PRS tone generator 114, attenuator 104, noise source 102 and transmitter 116 that are depicted in FIG. 1. Turning first to the transmitting side of the performance monitor 220, the optical test signal from the test signal generator 216 is received by a tunable filter 224 that selects the particular test channel or channels that are to be used for performance monitoring. As in the other embodiments of the invention, the test channels correspond to the idler channels employed in the transmission system. An optical switch 226 is used to select the data-carrying signal from the data transmitter 212 and one or more test channels from the tunable filter 224. A splitter 228 directs a portion of the signal received from the optical switch 226 to a Q-monitor 230. The Q-monitor 230 in turn can monitor the quality of the data-carrying signals received from the data transmitting unit 212. The Q-monitor 230 can also monitor the test channels to verify the operation of the Q-monitor 230 itself. If a problem arises with a particular channel in the data-carrying signal as indicated by a low Q-value, the Q-value of the test channel can then be measured. By comparing the Q-value for both the test channel and the data channel in which there is a problem at both the local and remote terminals, the problem with the data channel can be localized. In addition, if a loop-back path such as those depicted in FIG. 1 is employed at the end of transmission path near the receiving terminal, the Q-monitor 230 can also be used to monitor the test signals traversing optical fiber 252 during system deployment.

On the receiving side of the performance monitor 220, Q-monitor 232 can be used in a manner similar to monitor 230 to monitor system performance. In particular, the test signals generated by test signal generator 216 can be directed to the Q-monitor 232 via tunable filter 238, optical switch 234, and splitter 240. The Q-monitor 232 can also monitor the data-carrying signals received along fiber 252 as well as the test signals traversing optical fiber 250 during system deployment if loop-back paths are employed. It should, of course, be understood that while the present invention has been described in reference to specific hardware configurations, alternate configurations are possible. For example, in connection with FIG. 1, the PRS tone generator 114, delay system 120, and comparator/correlator 122 can be either optical components or electrical components. In addition, transmitter 116 may be a laser comb generator that produces signals at all channel wavelengths at which the transmission system is operational so that monitoring can be performed over any desired channel or channels that may serve as idler channels.

1. A test system for monitoring a WDM transmission system that employs at least one optical amplifier, comprising:
a test signal generator generating an optical test signal;
an optical coupler combining the test signal with at least one data signal located at a given channel wavelength, said optical test signal being located at one or more channel wavelengths distinct from the given channel wavelength and corresponding to an idler channel wavelength employed to maintain a prescribed operational state of said at least one optical amplifier; and
an optical performance monitor receiving at least a portion of the optical test signal.

2. The test system of claim 1 further comprising at least one optical loopback path associated with said at least one optical amplifier, said at least one optical loopback path optically coupling a first unidirectional optical transmission path to a second unidirectional optical transmission path and wherein said optical performance monitor receives a portion of the optical test signal conveyed over said at least one optical loopback path.

3. The test system of claim 1 wherein said test signal generator comprises:
a tone generator generating a tone having a pseudo-random sequence; and
an optical transmitter coupled to the tone generator and generating an optical test signal based on the pseudo-random tone;

4. The test system of claim 1 wherein said optical performance monitor comprises:
a delay system coupled to said tone generator and delaying the optical test signal based on a location of said at least one optical amplifier; and
a comparator coupled to said delay system correlating the output of the delay system with the pseudo-random tone generated by the tone generator.

5. The test system of claim 1 wherein said optical performance monitor includes a signal performance monitor for selectively monitoring said one or more channel wavelengths of the test signal and said at least one data signal.

6. The test system of claim 5 wherein said signal performance monitor is a Q-monitor.

7. A method for monitoring a WDM transmission system that employs at least one optical amplifier, said method comprising the steps of:
generating an optical test signal and at least one optical data signal located at a given channel wavelength, said optical test signal being located at one or more channel wavelengths distinct from the given channel wavelength and corresponding to an idler channel wavelength employed to maintain a prescribed operational state of said at least one optical amplifier;
directing said optical test signal and said at least one optical data signal onto an optical transmission path of the WDM transmission system; and
monitoring a performance characteristic of said optical test signal.

8. The method of claim 7 wherein said monitoring step comprises the step of receiving a portion of the optical test signal that has traversed at least one optical loopback path optically coupling a first unidirectional optical transmission path to a second unidirectional optical transmission path.

9. The method of claim 7 wherein the step of generating said optical test signal further comprising the steps of:
generating a tone having a pseudo-random sequence; and
generating said optical test signal based on the pseudo-random tone.

10. The method of claim 7 wherein said performance characteristic is a Q-value.

11. The method of claim 7 wherein said performance characteristic is selected from the group consisting of a Q-value, a bit error rate, and an optical-signal-to-noise ratio.

12. The method of claim 7 further comprising the step of monitoring a performance characteristic of said at least one optical data signal.

13. The method of claim 12 wherein said performance characteristic is a Q-value.

14. The method of claim 12 wherein said performance characteristic is selected from the group consisting of a Q-value, a bit error rate, and an optical-signal-to-noise ratio.

15. A WDM optical transmission system, comprising:
first and second transmitter/receiver terminals;
an optical transmission path optically coupling the first transmitter/receiver terminal to the second transmitter/receiver terminal, said optical transmission path including at least one optical amplifier;
a test system associated with the first transmitter/receiver terminal, said test system including:
a test signal generator generating an optical test signal;
an optical coupler combining the test signal with at least one data signal located at a given channel wavelength, said optical test signal being located at one or more channel wavelengths distinct from the given channel wavelength and corresponding to an idler channel wavelength employed to maintain a prescribed operational state of said at least one optical amplifier; and
an optical performance monitor receiving at least a portion of the optical test signal.

16. The WDM transmission system of claim 15 further comprising at least one optical loopback path associated with said at least one optical amplifier, wherein said optical transmission path includes first and second unidirection optical transmission paths, said at least one optical loopback path optically coupling said first unidirectional optical transmission path to said second unidirectional optical transmission path and wherein said optical performance monitor receives a portion of the optical test signal conveyed over said at least one optical loopback path.

17. The WDM transmission system of claim 15 wherein said test signal generator comprises:
a tone generator generating a tone having a pseudo-random sequence; and
an optical transmitter coupled to the tone generator and generating an optical test signal based on the pseudo-random tone;

18. The WDM transmission system of claim 15 wherein said optical performance monitor comprises:
a delay system coupled to said tone generator and delaying the optical test signal based on a location of said at least one optical amplifier; and
a comparator coupled to said delay system correlating the output of the delay system with the pseudo-random tone generated by the tone generator.

19. The WDM transmission system of claim 15 wherein said optical performance monitor includes a signal performance monitor for selectively monitoring said one or more channel wavelengths of the test signal and said at least one data signal.

20. The WDM transmission system of claim 19 wherein said signal performance monitor is a Q-monitor.
